(19) United States
(12) Patent Application Publication
(10) Pub. No.: US 2025/0329099 A1
(43) Pub. Date: Oct. 23, 2025

(54) GRAPHICS PROCESSING

(71) Applicant: Arm Limited, Cambridge (GB)

(72) Inventors: Daren Croxford, Swaffham Prior (GB); Frank Klaeboe Langtind, Melhus (NO); Robert William Genders, Bottisham (GB); Edvard Sørgård, Roeros (NO)

(73) Assignee: Arm Limited, Cambridge (GB)

(21) Appl. No.: 18/642,353

(22) Filed: Apr. 22, 2024

(51) Int. Cl. G06T 15/00; G06T 15/06; G06T 15/08; G06T 15/10

(52) U.S. Cl. CPC G06T 15/005; G06T 15/06; G06T 15/08; G06T 15/10

(57) ABSTRACT

When generating a render output representing a view of a scene comprising one or more objects, each object having a set of geometry defined for it, it is determined which sets of geometry should be processed for which region or regions of a plurality of regions into which the render output has been divided. The determination is made using a hierarchical data structure indicative of the distribution of geometry for the scene to be rendered in a world space. The hierarchical data structure represents a plurality of volumes in the world space that each contain one or more sets of geometry for the scene being rendered.

### BACKGROUND

The technology described herein relates to graphics processors, and in particular to the operation of a graphics processor when generating an output, e.g. a frame (image) for display.

FIG. 1 shows an exemplary system on-chip (SoC) graphics processing system 8 that comprises a host processor in the form of a central processing unit (CPU) 1, a graphics processor (GPU) 2, a display processor 3 and a memory controller 5.

As shown in FIG. 1, these units communicate via an interconnect 4 and have access to off-chip memory 6. In this system, the graphics processor 2 will render frames (images) to be displayed, and the display processor will then provide the frames to a display panel 7 for display.

In use of this system, an application 13 such as a game, executing on the host processor (CPU) 1 will, for example, require the display of frames on the display panel 7. To do this, the application will submit appropriate commands and data to a driver 11 for the graphics processor 2 that is executing on the CPU 1. The driver 11 will then generate appropriate commands and data to cause the graphics processor 2 to render appropriate frames for display and to store those frames in appropriate frame buffers, e.g. in the main memory 6. The display processor 3 will then read those frames into a buffer for the display from where they are then read out and displayed on the display panel 7 of the display.

Graphics processing is normally carried out by first dividing the output to be generated, such as a frame to be displayed, into a number of similar basic components (so-called “primitives”) to allow the graphics processing operations to be more easily carried out. These “primitives” are usually in the form of simple polygons, such as triangles.

Once the primitives have been generated and defined, they can be processed by the graphics processing system, in order, e.g., to display the frame.

In one graphics processing technique, this process basically involves determining which sampling positions in an array of sampling positions covering the output area to be processed are covered by a primitive, and then determining the appearance each sampling position should have (e.g. in terms of its colour, etc.) to represent the primitive at that sampling position. These processes are commonly referred to as rasterising and rendering, respectively.

The rasterising process determines the sample positions that should be used for a primitive (i.e. (the x, y) positions of the sample points to be used to represent the primitive in the output (e.g. frame to be displayed)).

(The term “rasterisation” is sometimes used to mean both primitive conversion to sample positions and rendering. However, herein “rasterisation” will be used to refer to converting primitive data to sampling point addresses only.)

The rendering process then derives the data, such as red, green and blue (RGB) colour values and an “alpha” (transparency) value, necessary to represent the primitive at the sample points (i.e. “shades” each sample point). This can involve applying textures, blending sample point data values, etc.

One form of graphics processing uses so-called “tile-based” rendering, in which the two-dimensional render output (e.g. the frame to be displayed) is rendered as a plurality of smaller area regions, usually referred to as “rendering tiles”. In tile-based graphics processing, the geometry (primitives) for the render output being generated is sorted into regions of the render output area, so as to allow the geometry (primitives) that need to be processed for a given region of the render output to be identified (so as to, e.g., avoid unnecessarily rendering primitives that are not actually present in a region).

Rather than using a rasterisation-based rendering scheme, as described above, another graphics processing technique that may be used for generating an output (e.g. a frame for display) is so-called “ray tracing”.

Ray tracing is a rendering process which involves tracing the paths of rays of light from a viewpoint (sometimes referred to as a “camera”) back through pixels in an image plane into a scene, and simulating the effect of the interaction between the rays and objects in the scene. The output data value, e.g. colour, of a pixel in the image plane is determined based on the object(s) in the scene intersected by the ray passing through the pixel, and the properties of the surfaces of those objects. The ray tracing calculation involves determining, for each pixel, a set of objects within the scene which a ray passing through the pixel intersects.

In some cases, a “hybrid” ray tracing process may be used, in which only some of the steps of a full ray tracing process are performed. For example, the first intersection of each ray with an object in the scene may be determined through rasterisation (rather than by casting a ray from the viewpoint into the scene), with the remainder of the process then being performed in the same manner as when carrying out “full” ray tracing. Thus, a hybrid ray tracing process includes both rasterisation and ray tracing processes.

The Applicants, however, believe that there remains scope for improved graphics processing arrangements.

### BRIEF DESCRIPTION OF THE DRAWINGS

Embodiments of the technology described herein will now be described by way of example only and with reference to the accompanying drawings, in which:

FIG. 1 shows an exemplary graphics processing system;

FIG. 2 is a schematic diagram illustrating a “full” ray tracing process;

FIG. 3 shows an exemplary ray tracing acceleration data structure;

FIG. 4 shows in more detail an exemplary multi-level arrangement of ray tracing acceleration data structures that may be used according to embodiments of the technology described herein;

FIG. 5 shows a process for generating ray tracing acceleration data structures;

FIG. 6 shows a process for updating ray tracing acceleration data structures for a render output to be rendered;

FIG. 7 is a flow chart illustrating an embodiment of a full ray tracing process;

FIG. 8 shows an alternative “hybrid” ray tracing process;

FIG. 9 shows a tile-based graphics processor that may be used to implement embodiments of the technology described herein;

FIG. 10 illustrates a tile-based graphics processing process;

FIG. 11 illustrates a hypertiling graphics processing process in accordance with an embodiment of the technology described herein;

FIG. 12 shows a hypertile sorting process in accordance with an embodiment of the technology described herein;

FIG. 13 shows a hypertile rasterization process in accordance with an embodiment of the technology described herein.

FIGS. 14A, 14B and 14C illustrates the intersection of a view frustum volume for a render output being generated with object instances in world space, in accordance with an embodiment of the technology described herein.

### DETAILED DESCRIPTION

A first embodiment of the technology described herein comprises a method of operating a graphics processor to generate a render output, the render output representing a view of a scene comprising one or more objects, each object having a set of geometry defined for it, the method comprising:
determining which sets of geometry should be further processed for which region or regions of a plurality of regions into which the render output has been divided for rendering; and
rendering a region of the render output by processing the sets of geometry determined to be further processed for that region,
wherein the determining which sets of geometry should be further processed for which region or regions of the plurality of regions into which a render output has been divided for rendering uses a hierarchical data structure representing a plurality of volumes in a world space coordinate system, wherein a volume contains one or more sets of geometry, the hierarchical data structure thus being indicative of the distribution of geometry for the scene to be rendered in the world space coordinate system.

A second embodiment of the technology described herein comprises a graphics processor operable to generate a render output, the render output
a set of geometry defined for it, the graphics processor comprising:
a sorting circuit operable to determine which sets of geometry should be further processed for which region or regions of a plurality of regions into which the render output has been divided for rendering;
a rendering circuit operable to render regions of the render output by processing sets of geometry determined to be further processed for that region;
wherein the sorting circuit is operable and configured to use a hierarchical data structure to determine which sets of geometry should be further processed for which region or regions of the plurality of regions into which a render output has been divided for rendering, the hierarchical data structure representing a plurality of volumes in a world space coordinate system, wherein a volume contains one or more sets of geometry, the hierarchical data structure thus being indicative of the distribution of geometry for the scene to be rendered in the world space coordinate system.

The technology described herein relates to a method of graphics processing wherein when generating a render output representing a view of a scene comprising one or more objects, each object having a set of geometry defined for it, the render output is divided into a plurality of regions, and an initial sorting process is performed to sort the geometry (e.g. primitives) for the render output (i.e. relating to the objects in the scene) relative to the regions into which the render output has been divided, i.e. so as to allow the sets of geometry to be (further) processed for the different regions to be identified.

For example, this initial, up-front sorting of the geometry into the different regions into which the render output has been divided may mean the graphics processor is better able exploit spatial locality in the geometry data, e.g., and in an embodiment, such that once the initial geometry sorting has been performed, different regions of the render output can then be processed (rendered) independently (e.g. in parallel). This may then mean that the amount of data to be transferred to/from memory at any particular instant can be (and in an embodiment is) reduced, at least compared to some more traditional graphics processing arrangements.

In the technology described herein, when performing such initial sorting of the geometry into different regions, rather than doing this sorting, e.g., based on positional data for the geometry (such as the vertex position data), the sorting is (instead) performed using a suitable hierarchical data structure (or a set of such structures) which is indicative of the distribution of geometry for the scene in world space (i.e. a world space coordinate system).

In particular, the hierarchical data structure that is used to perform such initial sorting according to the technology described herein represents a plurality of volumes in world space (e.g., and in an embodiment, with different nodes of the hierarchical data structure representing different respective volumes within the (world space) scene), wherein a (and in an embodiment each) volume can contain (i.e. is occupied by) one or more sets of geometry within the scene that the render output is being generated from, and this hierarchical data structure is then used to determine which regions of the render output different sets of geometry should be processed for.

(It will be understood in this regard that “world space” refers to the coordinate system for the scene being rendered, and is therefore distinct from, e.g., camera space, which is defined with respect to the viewpoint (or “camera”) of the scene that is being rendered.)

Thus, the technology described herein provides a method for (initially) sorting geometry into different regions into which the render output has been divided for rendering purposes and this initial sorting is done using, and based on, a suitable hierarchical data structure representing the volumes that the geometry occupies in world space.

In this respect, the Applicants have recognised that such a hierarchical data structure may be particularly suitable for sorting primitives into regions of the render output, since the hierarchical data structure (including the volumes containing the geometry) is defined in a world space coordinate system it may therefore be mostly static (i.e. unchanging) for successive render outputs (e.g. frames) that are being rendered, such that the hierarchical data structure will likely not need to be recalculated (or at least not recalculated in full) for each and every render output (frame) that is generated.

The Applicants have also recognised that, since the hierarchical data structure is based on world space coordinates, it can be used for sorting primitives into regions of the render output without the hierarchical data structure being required to be transformed, e.g., to a camera space. This may be in contrast to sorting using positional (e.g. vertex) data for the primitives, for example, wherein such data may need to be transformed into camera space (for each and every render output that is generated).

The technology described herein therefore provides a means for (efficiently) sorting geometry into processing regions in an embodiment without requiring (potentially computationally expensive) per-frame transformation processes to be carried out.

The technology described herein may therefore provide various benefits compared to other possible approaches.

The regions of the render output that the render output is divided into (for the purposes of having geometry sorted into) can be any suitable size or shape.

In an embodiment, all of the regions are the same size and shape, although this is not essential. In an embodiment, the render output is divided into relatively few (e.g. eight or fewer) regions. For example, and in an embodiment, the render output is divided into four regions (e.g. quadrants).

Thus, the technology described herein performs an initial sorting of the sets of geometry into the different regions of the render output that in an embodiment involves a relatively ‘coarser’ sorting of the geometry, and can in an embodiment therefore be done relatively quickly, with reduced processing burden (e.g. at least compared to the subsequent processing stages where the geometry data may be processed in full).

The initial sorting according to the technology described herein is therefore in an embodiment performed at a relatively ‘coarser’ granularity (e.g. the regions into which the render output is divided for rendering for the purposes of the initial sorting are in an embodiment (and typically) larger than the rendering tiles in a tile-based graphics processing system). For example, the initial sorting may be, and in an embodiment is, done to sort geometry into so-called “hypertiles”, as discussed in United States Patent Application (Publication) No. US 2023-0401667 (Arm Limited), and the entire content of which is incorporated herein by reference.

Various arrangements would however be possible in this regard and the regions into the render output is divided for rendering for the purposes of the initial sorting according to the technology described herein may generally comprise any suitable and desired (sized) regions.

In the technology described herein, as mentioned above, a hierarchical data structure (representing a plurality of volumes, wherein a volume can contain one or more sets of geometry) is used to determine which sets of geometry should be (further) processed for different regions of the render output.

In an embodiment, this is done by determining which of the volumes represented by the hierarchical data structure fall within a particular region the render output, with the one or more sets of geometry that occupy (i.e. are contained by) those volumes that do fall within the region then accordingly being determined as needing to be (further) processed for that region (and, conversely, with any sets of geometry that occupy (i.e. are contained by) volumes that do not fall within the region accordingly being determined as not needing to be (further) processed for that region).

The determination as to whether volume(s) represented by the hierarchical data structure fall within a given region can be made in any suitable or desired manner.

For example, it would be possible to determine whether volume(s) fall within the region of the render output by tracing rays through (e.g. respective sampling positions of) the region, to determine whether (e.g. any of) those rays intersect the volume(s) (represented by the hierarchical data structure).

However, in embodiments, this determination as to whether volume(s) represented by the hierarchical data structure fall within a given region is made by determining a corresponding volume that the region of the render output occupies in world space, which volume is in an embodiment then tested for intersection with the volume(s) represented by the hierarchical data structure.

In an embodiment, when the volume that the region occupies in world space is found to intersect (i.e. at least partially overlap) a volume represented by the hierarchical data structure, it is then determined on that basis that the volume represented by the hierarchical data structure falls within the region (such that geometry contained by that volume of the hierarchical data structure should be and in an embodiment is further processed for the region). Conversely, it is in an embodiment the case that when the volume that region occupies is found to not intersect (i.e. overlap) a volume represented by the hierarchical data structure, then it is determined on that basis that the volume of the hierarchical data structure does not fall within the region (such that the geometry contained by the volume of the hierarchical data structure should not be and in an embodiment isn't further processed for the region).

In an embodiment, this testing is done in a hierarchical manner, e.g. starting at a largest volume, e.g. represented by a root node of the hierarchical data structure, and then testing the volume that the region occupies in world space, as necessary, against any child volumes contained within that largest volume, and then for any child volumes that are intersected, proceeding to test any child volumes of those volumes, and so on, down to a set of lowest level volumes represented by the, e.g., leaf nodes of the hierarchical data structure.

Thus, the volume that the region occupies in world space is in an embodiment traversed through the hierarchical data structure to determine which volumes represented by the hierarchical data structure fall within the volume that the region occupies in world space (and hence which sets of geometry should be further processed when rendering that region of the render output).

In an embodiment, when it is determined that a higher level (i.e. larger) (e.g. root node) volume does not fall within (i.e. intersect with) the volume that the region occupies in world space, any lower level child volumes contained within that higher level larger volume are not required to be (and in an embodiment are not) tested against the volume that the region occupies (since, as will be understood, it will be known already from the testing of the higher level volume which contain those child volumes that those child volumes do not fall within the volume that the region occupies in world space). Rather, in this case, the testing can (and in an embodiment does) move on to another different higher level (i.e. larger) (e.g. root node) volume (if present), to determine whether that higher level volume falls within the volume occupied by the region, etc., and so on.

Testing (only) the higher level (e.g. root node) volumes against the volume occupied by the region and skipping lower level child volumes (where possible) in this manner allows geometry to be more efficiently and quickly sorted into regions (compared to, e.g. a process wherein all of the lower level volumes are tested against the volume occupied by the region). Thus, in an embodiment of the technology described herein, determining which sets of geometry should be further processed for which region or regions of the plurality of regions into which the render output has been divided comprises:
determining a volume in world space that a particular region of the render output corresponds to; and
testing the volume in world space that a particular region of the render output corresponds to for intersection with one or more volumes represented by the hierarchical data structure to determine whether the geometry contained within those volumes falls within the particular region and should thus be further processed for that particular region.

The volume in world space that the region of the render output corresponds to can be determined in any suitable or desired manner.

In an embodiment, the volume in world space that a region of the render output corresponds to that is determined is the volume of a view frustum for the region of the render output.

In an embodiment, a volume (in world space) for the view frustum of the scene to be rendered for the (entire) render output (e.g. frame) being generated is first determined, with this view frustum volume (for the entire render output) then being used to determine the view frustum volume for the particular region of the render output in question. For example, in an embodiment wherein a render output is divided into four equal regions, the view frustum for a particular region of the render output could be determined by taking an appropriate quarter (quadrant) of the volume of the view frustum for the entire render output.

(However it would, of course, be possible to instead determine the view frustum volume for the region more directly, i.e. without first determining the volume of the view frustum for the entire render output, if desired.).

Thus, according to another embodiment of the technology described herein, determining a volume in world space that a region of the render output corresponds to comprises determining a volume in world space of the view frustum of the scene to be rendered, and determining the volume in world space that the region of the render output corresponds to based on the determined volume in world space of the view frustum.

In an embodiment, the view frustum volume (in world space) is determined based on its back plane, front plane, and four sides (top, bottom, left right).

As mentioned above, the view frustum volume (in world space) for a (and each) particular region of the render output is in an embodiment then tested against the hierarchical data structure to determine which volumes represented by the hierarchical data structure fall within the view frustum for the particular region of the render output (and hence which sets of geometry should be further processed when rendering that region of the render output).

In the technology described herein, once it has been determined which sets of geometry should be processed for a particular region of the render output (based on the hierarchical data structure), the region of the render output should then be (and in an embodiment is) rendered by processing those sets of geometry.

For instance, as a result of the initial sorting (in whichever manner it is performed), it is thus determined which sets of geometry are to be processed for which regions of the render output, and one or more lists are in an embodiment thereby generated indicating the same.

The initial sorting operation is then finished. Each sorting region (hypertile) can then be rendered separately (e.g. in parallel), e.g. in a second or further processing pass, with reference to the respective list (or lists) for that region.

The rendering of individual regions of the render output can be carried out in any suitable or desired manner, e.g. according to any suitable and desired rendering process known in the art. For instance, the rendering of a hypertile could be done using immediate mode rendering or tile-based rendering.

In the case of immediate mode rendering, the graphics processor would simply take each region in turn and perform immediate mode rendering to render the region. This is still advantageous, because the initial sort into regions should then ensure better spatial locality for the immediate mode rendering process.

In the case of tile-based rendering using the regions, then in the typical situation where the rendering tiles are smaller than the regions into which the geometry was initially sorted, the first stage in the second or further processing pass is in an embodiment to then prepare and store (in an embodiment on-chip) tile lists for the individual rendering tiles, with each individual rendering tile then being rendered in turn using the rendering tile tile lists in the normal manner.

Thus, in embodiments, the rendering of the sets of geometry for the regions of the render output is performed using tile-based rendering, wherein each of the regions that the render output was divided into for sorting is subdivided into a plurality of rendering tiles, each rendering tile representing a sub-area of the render output region, and the rendering of a region comprises a step of preparing a set of one or more tile list(s) indicating which of the sets of geometry that have been indicated to be processed for the region should be processed for which of the rendering tiles.

Thus in this case, there will potentially be two “tiling” operations, the first to perform the initial sorting into the (larger) regions (e.g. ‘hypertiles’), and then for each (hypertile) region (separately), a separate tiling process to prepare rendering tile lists for the rendering tiles within the (hypertile) region.

Thus, in embodiments, the processing of the sets of geometry to generate a render output is performed using tile-based rendering, wherein each of the regions that the render output was divided into for sorting is subdivided into a plurality of rendering tiles, each rendering tile representing a sub-area of the render output region, and wherein the rendering of a region comprises a step of preparing a set of one or more tile list(s) indicating which of the sets of geometry that have been indicated to be processed for the region should be processed for which of the rendering tiles.

The actual rendering operation can then be performed in any suitable and desired fashion. For instance, in some embodiments, the rendering that is performed comprises a rasterization-based rendering scheme, e.g. as described above. In that case, the rasterization, fragment shading, etc., processes can then be performed in the normal manner for each rendering tile, e.g. in turn.

In embodiments, however, the rendering that is performed for a region comprises a ray tracing process, and in an embodiment a hybrid ray tracing process.

Thus, in an embodiment of the technology described herein, the method further comprises (and the system is correspondingly configured to) also performing ray tracing using the (same) hierarchical data structure, in an embodiment as part of a hybrid ray tracing rendering scheme (and so, as will be discussed further below, the hierarchical data structure is in an embodiment also a “ray tracing acceleration data structure” that can be (and in an embodiment is) traversed as part of a ray tracing process in order to accelerate the ray tracing process (and so the hierarchical data structure may also be referred to as a “ray tracing acceleration data structure”)).

In such embodiments wherein the rendering is carried out using a (hybrid) ray tracing process, this ray tracing process (including, e.g., the determination as to whether individual rays intersect (e.g. volumes of) instances of objects in the scene being rendered) is in an embodiment performed using the (same) hierarchical data structure that is used for the initial sorting of geometry described above.

That is, the (same) hierarchical data structure that is used for the initial sorting of geometry is in an embodiment also used as a ray tracing acceleration data structure.

Thus, a particular effect and benefit of the technology described herein in such embodiments where a (hybrid) ray tracing rendering process is used is that the hierarchical data structure that is used for the initial sorting of geometry may, and in an embodiment does, comprise a (or at least part of a) data structure that is already being provided as part of the rendering process in order to carry out ray tracing (which existing data structure can thus be, and is, suitably also used for the extra purpose of sorting primitives into region of the render output, according to the method of the technology described herein).

The Applicants have thus recognised that the technology described herein may be particular advantageous in such embodiments where a (hybrid) ray tracing rendering process is used, since the same hierarchical data structure (e.g. that is already being provided for use for the ray tracing process) can be used both to sort primitives into regions of the render output (in the manner of the technology described herein as described above) and to accelerate the ray tracing process.

Another benefit in this regard is that the initial sorting of geometry can, and in an embodiment does, utilise any dedicated (hardware) ray tracing circuits (units) that the graphics processor may include to perform the initial sorting of geometry.

That is, the graphics processor may, and in an embodiment does, comprise one or more ray tracing circuit (unit) to which some or all of a ray tracing process can be offloaded (e.g. rather than the ray tracing process being performed by the programmable execution unit), which ray tracing circuit (unit) thus acts as an accelerator for (at least some) ray tracing operations.

In embodiments, this same ray tracing circuit (unit) can thus also be used, as desired, to perform the initial sorting of geometry in the manner of the technology described herein, and this then also allows the initial sorting of geometry to be performed in a more efficient manner (e.g. compared to using general purpose (compute) shader programs to do this), and this can be done without significantly increasing silicon area, i.e. by repurposing existing (hardware) circuitry.

Various arrangements would be possible in this regard.

Thus, in an embodiment of the technology described herein, the graphics processor comprises a programmable execution unit operable to execute graphics processing programs and also comprises a ray tracing circuit that can be messaged by the programmable execution unit as part of a program to perform ray tracing to perform some or all of the ray tracing operation, and wherein some or all of the determining which sets of geometry should be processed for which region or regions of a plurality of regions into which the render output has been divided for rendering is performed using the ray tracing circuit.

Subject to the particular requirements of the technology described herein, the hierarchical data structure may generally take any suitable and desired form.

For instance, in embodiments wherein ray tracing is performed using the hierarchical data structure, the hierarchical data structure in an embodiment comprises a data structure that is suitable for use in ray tracing rendering processes, i.e. the hierarchical data structure can also be (and is also) used as a “ray tracing acceleration data structure”. (However, it should be understood that the hierarchical data structure may also, and in an embodiment does, comprise such a data structure in embodiments wherein ray tracing is not being carried out.)

In an embodiment, the hierarchical data structure comprises a tree structure, e.g. and, in an embodiment, comprising a plurality of end (leaf) nodes, at least some of which may represent one or more sets of geometry defined within the respective volume that the leaf node corresponds to, and with the non-leaf (non end) nodes representing hierarchically-arranged larger volumes up to a root node at the top level of the tree structure that represents an overall volume for the scene in question that the tree structure corresponds to. Each non-leaf node is therefore in an embodiment a parent node for a respective set of plural child nodes, with the parent node volume encompassing the volumes of its respective child nodes.

For example, in an embodiment, the hierarchical data structure comprises a bounding volume hierarchy (BVH) tree data structure. However, the hierarchical data structure could comprise another suitable type of data structure (that is subject to the constraints required by the technology described herein), such as, e.g., a k-tree data structure, that may suitably be used for sorting (and optionally also for ray tracing acceleration).

At least in the case where the hierarchical data structure is in the form of a tree structure, there will be “higher level”, non-leaf, nodes that represent respective volumes of the scene and have one or more respective child nodes, representing smaller volumes of the scene (and that should be, and that are in an embodiment, encompassed within the volume that the higher level, “parent” node represents), together with one or more, and in an embodiment plural, “end” (leaf) nodes of the data structure.

Thus, in an embodiment, the hierarchical data structure comprises one or more, and in an embodiment plural, higher-level, non-end, nodes that represent larger volumes of the scene (which may accordingly be referred to as “box” nodes), and that correspondingly (each) have one or more child nodes that represent smaller volumes of the scene within the volume of the parent node, and one or more end (leaf) nodes which are the end nodes in the ray tracing acceleration (i.e. hierarchical) data structure (and thus which may not, and in an embodiment do not, have any child nodes of their own).

In an embodiment, in the case where the hierarchical data structure is in the form of a tree structure (such as a BVH), the volumes of the hierarchical data structure are tested against the volume (in world space) occupied by a region of the render output in a hierarchical manner (e.g. as described above), by starting at a higher level (e.g. root node) volume of the hierarchical data structure, to determine whether that higher level volume falls within the region, and then, if it is determined that the higher level node volume does fall within the region, testing any child (i.e. lower level) volume nodes of that higher level volume node against the volume occupied by the region to determine whether those child volume nodes fall within the region (thereby moving down a “branch” of the tree), etc. and so on, down to a (e.g. predetermined) level of volume nodes (e.g. leaf nodes) of the hierarchical data structure.

In an embodiment, when it is determined that a particular volume in (a first branch of) the hierarchical data structure tree does not fall within the volume occupied by the region, the process moves on to a different branch of the tree by testing another higher level (e.g. root node) volume (belonging to the different branch of the tree) against the volume occupied by the region of the render output (without testing any child volumes of the particular volume (in the first branch of the tree) against the volume that the region occupies).

Thus, in an embodiment, a “traversal” of the hierarchical data structure is performed in which the volume (in world space) occupied by a region of the render output is traversed through the hierarchical data structure by testing the hierarchical data structure against the respective volumes represented by the hierarchical data structure. Such traversal can be performed and managed in any suitable and desired manner, e.g. in a similar manner to performing and managing a traversal of such hierarchical data structures in a ray tracing, except that the traversal is performed in respect of the volume (in world space) occupied by a region of the render output rather than ray that is being used for the ray tracing process.

Various arrangements would be possible in this regard.

At least some of (and in some embodiments, all of) the leaf (end) nodes of the hierarchical data structure in an embodiment can, and in some embodiments do, represent and indicate (actual) geometry in the scene being rendered. Other arrangements would however be possible. For example, a leaf (end) node of a hierarchical data structure may also point to another data structure, in particular another (lower level) hierarchical data structure that is to be traversed in a similar manner, and which another (lower level) hierarchical data structure may represent and indicate (actual) geometry in the scene being rendered.

For example, in an embodiment, at least some of the volumes represented by the hierarchical data structure (which are used to determine whether the geometry contained with these volumes should be processed for a region (e.g. because they fall within the region), as described above) correspond to the volumes occupied by instances of (one or more) objects in the scene that is being rendered, (rather than, e.g., the volumes occupied by individual sets of geometry only).

(As will be understood, a particular object (e.g. a tree) may appear multiple times in a scene (and hence there may be multiple “instances” of the same object for a scene being rendered).)

These volumes (occupied by instances of entire objects in the scene) can be used to sort entire instances of entire objects in the scene into regions of the render output, thereby providing a relatively “coarse” sort compared to, e.g. sorting based on the (typically much smaller) volumes occupied by individual sets of geometry themselves.

In embodiments wherein the hierarchical data structure comprises a BVH tree data structure, the BVH tree data structure in an embodiment comprises a two-level arrangement of data structures which includes a top level acceleration data structure (TLAS) and one or more (and in an embodiment plural) bottom level acceleration data structures (BLAS) (in an embodiment with each of the BLAS being associated with a respective object or model of an object).

In an embodiment, the BLAS is in the form of a respective BVH tree, with at least some of the leaf nodes of the BLAS storing (one or more sets of) geometry that is associated with objects in the scene being rendered.

In an embodiment, the TLAS is (also) in the form of a respective BVH tree. In an embodiment the TLAS comprises one or more, and in an embodiment plural, higher level, non end, nodes that represent larger volumes of the scene, and one more or more, and in an embodiment plural, lower level, leaf nodes that correspond to (volumes of) instances of (one or more) objects in the scene that is being rendered, with leaf nodes of the TLAS (relating to instances of one or more objects) pointing to one or more of the BLAS that contain the set(s) of geometry associated with the respective one or more objects. Thus, in an embodiment a leaf node of the TLAS represents a volume in which there are contained one or more BLAS.

The applicants have recognised in this regard that, whilst it would be possible when sorting primitives into regions of the render output to do so on the basis of, e.g., both the TLAS and BLAS (to determine whether volumes that sets of geometry occupy fall within a region of the render output), it can be especially efficient to use the TLAS for this purpose (and in particular to use only the TLAS for this purpose), since the TLAS, in representing instances of the objects in the scene, provides an appropriately “coarse” set of volumes (that sets of geometry occupy) that is particularly suitable for carrying out a correspondingly “coarse” sort of the sets of geometry for scene being rendered.

Thus, in an embodiment, the bounding volume hierarchy tree data structure comprises a top-level acceleration structure (TLAS) wherein at least some leaf nodes of the top-level acceleration structure represent instances of objects within the scene, wherein an (and each) instance of an object within the scene is associated with a respective bottom-level acceleration structure (BLAS), at least some leaf nodes of the bottom-level acceleration structure (BLAS) containing the sets of geometry for the associated object, and wherein the determining which sets of geometry should be further processed for which region or regions of the plurality of regions into which the render output has been divided for rendering comprises determining whether a volume represented by the top-level acceleration structure (TLAS) falls within a region of the render output.

In an embodiment, the determining which sets of geometry should be further processed for which region or regions of the plurality of regions into which the render output has been divided for rendering only uses the top-level acceleration structure (TLAS) (and does not use any of the bottom-level acceleration structure (BLAS's)).

In these embodiments, although the bottom-level acceleration structure (BLAS) is not used for the purpose of sorting geometry into regions of the render output (in the manner described above), the bottom-level acceleration structure (BLAS) can be, and in an embodiment is, still used for subsequent rendering of the region(s) (at least when that is done by a (hybrid) ray tracing rendering scheme).

The hierarchical data structure may comprise multiple different sets of geometry (e.g. of different complexities) associated with different levels of detail (LoD) for one or more objects in the scene being rendered. For example, in some embodiments, a given object in the scene being rendered may be associated with a number of different bottom-level acceleration structure (BLAS), corresponding to different LoDs for that object, e.g. with a leaf node of the top-level acceleration structure (TLAS) (representing an instance of that object) pointing to one or more, and in an embodiment each, of those bottom-level acceleration structures (BLAS's).

In some of these embodiments, when actually performing subsequent rendering, a particular (e.g. singular) bottom-level acceleration structure (BLAS) (of the plurality of bottom-level acceleration structures (BLAS's) to which the top-level acceleration structure (TLAS) node points) is used for actually performing the rendering.

Thus, in the case where a same volume represented by a top-level acceleration structure (TLAS) is determined to fall within multiple regions of the render output, in some embodiments the same bottom-level acceleration structure (BLAS) (of the plurality of bottom-level acceleration structures (BLAS's) to which the top-level acceleration structure (TLAS) node points) is used for performing the rendering for each of those regions (and so in an embodiment this is done).

The particular bottom-level acceleration structure (BLAS) (i.e. having a particular LoD) that is used for rendering may be chosen based on any suitable or desired criteria. For example, the particular bottom-level acceleration structure (BLAS) that is used may be chosen according to the distance of the instance (of the object) from the camera (e.g. such that a bottom-level acceleration structure (BLAS) with a lower LoD (i.e. a simpler model) is chosen when the camera is further from the instance, etc.). The particular bottom-level acceleration structure (BLAS) may also (or instead) be chosen based on, e.g., the size of the object, the speed of the object, and/or the angle of the surface normal from the camera (since, as will be understood, the angle may determine to what extent the object is pointing towards the camera (and hence what complexity is suitable)).

Although in embodiments (described above) the TLAS (only) is used for the purposes of determining which sets of geometry should be processed for which region, it would be possible in other embodiments to use the full data structure, including the BLASs, for the initial sorting, e.g. depending on the size of the region(s) into which the geometry is being sorted.

For instance, as will be understood, the BLAS will provide a “finer” set of volumes (compared to the TLAS), which may be less desirable (and not necessary) to use for the sorting process when the regions which primitives are being sorted into are much larger than those “fine” volumes, but may be more appropriate in arrangements wherein the regions of the render output which primitives are sorted into are smaller (and, e.g., of comparable size to the volumes of the BLAS).

For example, in some embodiments the BLAS is used (or, in some embodiments, at least a portion thereof) for the purpose of sorting primitives into regions when those regions correspond to (smaller) tiles of the render output, e.g. for sorting geometry relative to rendering tiles in a tile-based graphics processing system, and in some embodiments this may be done.

In embodiments wherein the BLAS is used for the purposes of sorting primitives, it would be possible to use all levels of the BLAS for this purpose (up to an including the leaf nodes of the BLAS). However, in some embodiments rather than use all levels of the BLAS for this purpose, instead only one or more “higher” levels of the BLAS (i.e. corresponding to relatively larger volumes) are used (e.g. with one or more “lower” levels of the BLAS, corresponding to relatively finer volumes, not being used).

Various arrangements would be possible in this regard. In some embodiments, the geometry for objects in the scene (which is contained in the hierarchical data structure) is grouped together in “clusters”, wherein a (and each) cluster in an embodiment provides spatially local geometry with similar surface normal. For example, the BLAS that describes a particular object can be split into clusters, with different branches of the cluster providing a different geometric LoD (complexity).

In these arrangements, the hierarchical data structure may, e.g., comprise a Cluster Level Acceleration Structure (CLAS) (in addition to the TLAS and BLAS), wherein nodes of the TLAS (representing instances of an object) point to the CLAS (for the object), and the CLAS for the object points to the BLAS for the cluster. Alternatively, in other embodiments, wherein the BLAS comprises various nodes (volumes) including leaf nodes for primitives, at least some of the nodes of the BLAS (e.g. at a certain level of the BLAS) may represent volumes of clusters.

In some embodiments wherein the geometry is clustered, the sorting of sets of geometry into regions of the render output is carried out on the basis of the relatively “coarse” TLAS only (to determine whether a volume of an instance of an object/cluster represented by the TLAS falls within a region of the render output), although this need not necessarily be the case, and it would be possible to use, e.g. the CLAS, for this purpose.

However, when actually performing subsequent rendering, in an embodiment an appropriate cluster geometry (having an appropriate complexity) is chosen and used for rendering of the region.

The cluster geometry that is used for rendering may be chosen based on any e.g. according to the distance of the object from the camera, the size of the object, the speed of the object, and/or the angle of the surface normal from the camera (since, as will be understood, the angle may determine to what extent the object is pointing towards the camera (and hence what complexity is suitable)).

Thus, in embodiments, the initial sorting operation may use than all of a given hierarchical data structure, or set of hierarchical data structures, that are defined for the scene in question, and various arrangements would be possible in this regard.

As discussed above, in embodiments wherein ray tracing is to be performed, the hierarchical data structure is in an embodiment used for both the sorting process and for performing the ray tracing.

However, this need not necessarily be the case, and even in the case wherein ray tracing is performed it would be possible to use (and e.g. generate) a dedicated hierarchical data structure which is used for the purposes of sorting primitives into regions but which is not used for ray tracing. For example, it would be possible to use an hierarchical data structure for performing ray tracing, but to use a dedicated (e.g. different, e.g. coarser) hierarchical data structure for the purpose of the initial sorting of geometry into different regions.

Various arrangements would be possible in this regard.

The hierarchical data structure that is used in the technology described herein can be generated and provided in any suitable or desired manner. For example, the hierarchical data structure may be determined and provided, e.g., as part of the definition of the scene to be rendered by the application that requires the graphics processing.

In an embodiment, the hierarchical data structure is generated by the graphics processor itself, e.g. based on an indication of geometry for the scene that is provided to the graphics processor, e.g. in a preliminary processing pass before the scene is rendered.

The hierarchical data structure could also or instead be generated by a host processor (e.g. CPU) of a data processing system that the graphics processor is a part of, e.g. based on an indication of geometry for the scene, e.g. in a preliminary processing pass before the scene is rendered.

Other arrangements would, of course, be possible.

As discussed above, the hierarchical data structure represents a plurality of volumes in world space (that contain one or more sets of geometry for the scene being rendered). Since the hierarchical data structure is based on world space coordinates, the hierarchical data structure may be mostly static (i.e. unchanging) for successive render outputs (e.g. frames) that are generated. (For example, a volume of the hierarchical data structure that corresponds to the volume occupied by an instance of a particular object may only change from render output to render output if that object has changed or moved.)

Accordingly, in embodiments, the hierarchical data structure need not (and in an embodiment isn't) recalculated in full for each and every render output that is generated.

Rather, when generating a new render output, the hierarchical data structure for the render output (that is used for sorting geometry) is in an embodiment generated by updating (some but not all parts of) the hierarchical data structure that was used (to sort geometry) when generating a previous render output (with only the relevant parts of the hierarchical data structure being modified/updated according to changes in the scene that have occurred (e.g. an object having moved or changed)).

Thus, in an embodiment the hierarchical data structure that is used when generating a render output is based (at least in part) on the hierarchical data structure that was used when generating a previous render output.

Thus, according to an embodiment, the hierarchical data structure indicative of the distribution of geometry for the scene to be rendered is generated by updating some but not all of a hierarchical data structure indicative of the distribution of geometry for a scene represented by a render output that was previously rendered by the graphics processor.

Once it has been determined which sets of geometry should be processed for which region of the render output in accordance with the technology described herein, this can be tracked in any suitable or desired way.

In embodiments, this is done using a list for a (and in an embodiment each) region of the render output, that contains the sets of geometry (or information that can be used to retrieve the sets of geometry, e.g. information relating to the instances of objects which fall within the region of the render output that can be used to retrieve the sets of geometry relating to those objects) that should be processed for that region.

Other arrangements would of course be possible, however.

As discussed above, in embodiments, the sorting process of the technology described herein is used to perform an initial sorting of the geometry into (larger) regions, with a separate tiling process then performed for each region (separately) in which rendering tile lists are prepared for each of the rendering tiles within a region.

However, this need not necessarily be the case, and other arrangements would, of course, be possible, e.g., depending on the desired size of the regions into which the render output is divided for sorting purposes,.

For example, the sorting described above may also be performed as part of the (normal) tiling operations, i.e. to sort geometry relative to rendering tiles. Thus it would be possible to use the sorting process of the technology described herein to directly sort geometry into rendering tile “regions” (e.g. without performing an initial “coarser” sorting of the geometry into larger regions of the render output).

In embodiments wherein the sorting process of the technology described herein is used to sort geometry into (smaller) rendering tiles, this is in an embodiment done using a less “coarse” set of volumes represented by the hierarchical data structure (compared to embodiments described above wherein a more “coarse” set of volumes is used to sort geometry into (larger) regions). For example, in embodiments wherein the hierarchical data structure comprises a two-level BVH tree which includes a top-level acceleration data structure (TLAS) and one or more bottom-level acceleration data structure (BLAS), the sorting of geometry into the smaller rendering tiles can be (and in an embodiment is) done using the full BVH tree including both the top-level acceleration data structure (TLAS) and some or all of a bottom-level acceleration data structure (BLAS), as appropriate.

Although in embodiments described above, the hierarchical data structure has been described as a single data structure, it should be understood that the hierarchical data structure could itself comprise, e.g., multiple sets of (e.g. separate) hierarchical data structures (with any or all of these hierarchical data sets being used for the sorting process of the technology described herein, as discussed above). For example, and as discussed above, the hierarchical data structure can comprise one or more bottom-level acceleration data structure (BLAS) and a top-level acceleration data structure (TLAS) (both of which could themselves be considered to be hierarchical data structures).

The above describes the main elements and operation of a graphics processor that are relevant to operation in the manner of the technology described herein.

The technology described herein can be used for all forms of output that a graphics processor may be used to generate. In particular, the technology described herein may be used both for generating graphics processing outputs, such as frames for display, render to texture outputs, etc., or for general purpose (non-graphics) outputs.

As will be appreciated by those skilled in the art, the graphics processor can otherwise include and execute, and in an embodiment does include and execute, any one or one or more, and in an embodiment all, of the pipeline stages and circuits that graphics processors and graphics processing pipelines may (normally) include.

In an embodiment, the graphics processor comprises, and/or is in communication with a memory system, one or more memories, and/or memory devices that store the data described herein, and/or that store software for performing the processes described herein. The graphics processor may also be in communication with a host microprocessor, and/or with a display for displaying images based on the output of the graphics processor.

The output to be generated may comprise any output that can and is to be generated by the graphics processor. Thus it may comprise, for example, a tile to be generated in a tile based graphics processing system, and/or a frame of output fragment data. The technology described herein can be used for all forms of output that a graphics processor may be used to generate, such as frames for display, render-to-texture outputs, etc. In an embodiment, the output is an output frame, and in an embodiment an image. However, in general the graphics processors of the technology described herein may be used both for performing graphics processing work, such as generating frames for display, etc., or for performing general purpose (non-graphics) work, as desired.

In an embodiment, the various functions of the technology described herein are carried out on a single graphics processing platform that generates and outputs the (rendered) data that is, e.g., written to a frame buffer for a display device.

The various functions of the technology described herein can be carried out in any desired and suitable manner. For example, unless otherwise indicated, the functions of the technology described herein can be implemented in hardware or software, as desired. Thus, for example, unless otherwise indicated, the various functional elements, stages, and “means” of the technology described herein may comprise a suitable processor or processors, controller or controllers, functional units, circuitry, circuits, processing logic, microprocessor arrangements, etc., that are configured to perform the various functions, etc., such as appropriately dedicated hardware elements (processing circuits/circuitry) and/or programmable hardware elements (processing circuits/circuitry) that can be programmed to operate in the desired manner.

It should also be noted here that, as will be appreciated by those skilled in the art, the various functions, etc., of the technology described herein may be duplicated and/or carried out in parallel on a given processor. Equally, the various pipeline stages may share processing circuitry/circuits, etc., if desired.

Furthermore, unless otherwise indicated, any one or more or all of the pipeline stages of the technology described herein may be embodied as pipeline stage circuits, e.g., in the form of one or more fixed-function units (hardware) (processing circuits), and/or in the form of programmable processing circuits that can be programmed to perform the desired operation. Equally, any one or more of the pipeline stages and pipeline stage circuitry of the technology described herein may be provided as a separate circuit element to any one or more of the other pipeline stages or pipeline stage circuits, and/or any one or more or all of the pipeline stages and pipeline stage circuits may be at least partially formed of shared processing circuits.

Subject to any hardware necessary to carry out the specific functions discussed above, the graphics processor can otherwise include any one or more or all of the usual functional units, etc., that graphics processors include.

It will also be appreciated by those skilled in the art that all of the described embodiments of the technology described herein can, and, in an embodiment, do, include, as appropriate, any one or more or all of the features described herein.

The methods in accordance with the technology described herein may be implemented at least partially using software e.g. computer programs. It will thus be seen that the technology described herein herein may provide computer software specifically adapted to carry out the methods herein described when installed on a data processor, a computer program element comprising computer software code portions for performing the methods herein described when the program element is run on a data processor, and a computer program comprising code adapted to perform all the steps of a method or of the methods herein described when the program is run on a data processing system. The data processor may be a microprocessor system, a programmable FPGA (field programmable gate array), etc.

The technology described herein also extends to a computer software carrier comprising such software which when used to operate a display controller, or microprocessor system comprising a data processor causes in conjunction with said data processor said controller or system to carry out the steps of the methods of the technology described herein. Such a computer software carrier could be a physical storage medium such as a ROM chip, CD ROM, RAM, flash memory, or disk, or could be a signal such as an electronic signal over wires, an optical signal or a radio signal such as to a satellite or the like.

It will further be appreciated that not all steps of the methods of the technology described herein need be carried out by computer software and thus, in a further broad embodiment the technology described herein provides computer software and such software installed on a computer software carrier for carrying out at least one of the steps of the methods set out herein.

The technology described herein may accordingly suitably be embodied as a computer program product for use with a computer system. Such an implementation may comprise a series of computer readable instructions either fixed on a tangible, non-transitory medium, such as a computer readable medium, for example, diskette, CDROM, ROM, RAM, flash memory, or hard disk. It could also comprise a series of computer readable instructions transmittable to a computer system, via a modem or other interface device, over either a tangible medium, including but not limited to optical or analogue communications lines, or intangibly using wireless techniques, including but not limited to microwave, infrared or other transmission techniques. The series of computer readable instructions embodies all or part of the functionality previously described herein.

Those skilled in the art will appreciate that such computer readable instructions can be written in a number of programming languages for use with many computer architectures or operating systems. Further, such instructions may be stored using any memory technology, present or future, including but not limited to, semiconductor, magnetic, or optical, or transmitted using any communications technology, present or future, including but not limited to optical, infrared, or microwave. It is contemplated that such a computer program product may be distributed as a removable medium with accompanying printed or electronic documentation, for example, shrinkwrapped software, preloaded with a computer system, for example, on a system ROM or fixed disk, or distributed from a server or electronic bulletin board over a network, for example, the Internet or World Wide Web.

Embodiments of the technology described herein will now be described by way of example only and with reference to the accompanying drawings.

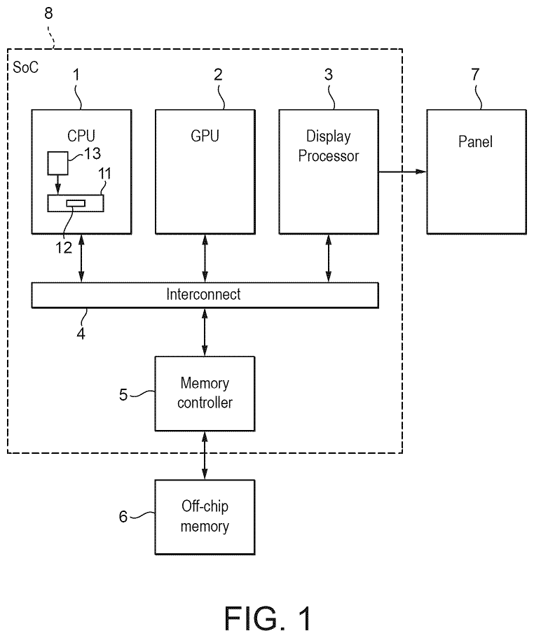

The present embodiments relate particularly to the operation of a graphics processor, e.g. in a graphics processing system as illustrated in FIG. 1.

By way of background, a “ray tracing” process will now be described. Ray tracing is a rendering process which involves tracing the paths of rays of light from a viewpoint (sometimes referred to as a “camera”) back through sampling positions in an image plane (which is the frame being rendered) into a scene, and simulating the effect of the interaction between the rays and objects in the scene. The output data value e.g. colour of a sampling position in the image is determined based on the object(s) in the scene intersected by the ray passing through the sampling position, and the properties of the surfaces of those objects. The ray tracing process thus involves determining, for each sampling position, a set of objects within the scene which a ray passing through the sampling position intersects.

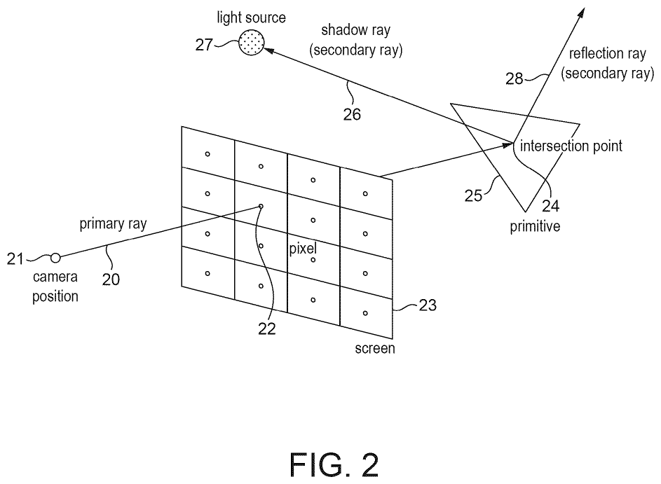

FIG. 2 illustrates an exemplary “full” ray tracing process. A ray 20 (the “primary ray”) is cast backward from a viewpoint 21 (e.g. camera position) through a sampling position 22 in an image plane (frame) 23 into the scene that is being rendered. The point 24 at which the ray 20 first intersects an object 25, e.g. a primitive (which primitives in the present embodiments are in the form of triangles, but may also comprise other suitable geometric shapes), in the scene is identified. This first intersection will be with the object in the scene closest to the sampling position.

A secondary ray in the form of shadow ray 26 may be cast from the first intersection point 24 to a light source 27. Depending upon the material of the surface of the object 25, another secondary ray in the form of reflected ray 28 may be traced from the intersection point 24. If the object is, at least to some degree, transparent, then a refracted secondary ray may be considered.

Such casting of secondary rays may be used where it is desired to add shadows and reflections into the image. A secondary ray may be cast in the direction of each light source (and, depending upon whether or not the light source is a point source, more than one secondary ray may be cast back to a point on the light source).

In the example shown in FIG. 2, only a single bounce of the primary ray 20 is considered, before tracing the reflected ray back to the light source. However, a higher number of bounces may be considered if desired.

The output data for the sampling position 22 i.e. a colour value (e.g. RGB (Red, Green, Blue) or RGBA (RGB plus Alpha) value) thereof, is then determined taking into account the interactions of the primary, and any secondary, ray(s) cast, with objects in the scene. The same process is conducted in respect of each sampling position to be considered in the image plane (frame) 23.

In order to facilitate such ray tracing processing, in the present embodiments acceleration data structures indicative of the geometry (e.g. objects) in scenes to be rendered are used when determining the intersection data for the ray(s) associated with a sampling position in the image plane to identify a subset of the geometry which a ray may intersect.

The ray tracing acceleration data structure represents and indicates the distribution of geometry (e.g. objects) in the scene being rendered, and in particular the geometry that falls within respective (sub-) volumes in the overall volume of the scene (that is being considered). In the present embodiments, ray tracing acceleration data structures in the form of Bounding Volume Hierarchy (BVH) trees are used.

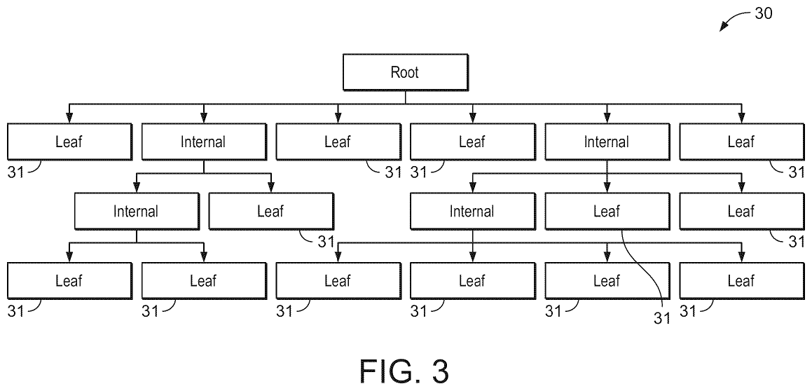

FIG. 3 shows an exemplary BVH tree 30, constructed by enclosing a volume in an axis-aligned bounding volume (AABV), e.g. a cube, and then recursively subdividing the bounding volume into successive sub-AABVs according to any suitable and desired subdivision scheme, until a desired smallest subdivision (volume) is reached.

In this example, the BVH tree 30 is a relatively “wide” tree wherein each bounding volume is subdivided into up to six sub-AABVs. However, in general, any other suitable tree structure may be used, and a given node of the tree may have any suitable and desired number of child nodes.

Thus, each node in the BVH tree 30 will have a respective volume associated with it, with the end, leaf nodes 31 each representing a particular smallest subdivided volume, and any parent node representing, and being associated with, the volume of its child nodes.

A complete scene may be represented by a single BVH tree, e.g. with the tree storing the geometry for the scene in world space. In this case, each leaf node of the BVH tree 30 may be associated with the geometry defined for the scene that falls, at least in part, within the volume that the leaf node corresponds to (e.g. whose centroid falls within the volume in question). The leaf nodes 31 may represent unique (non-overlapping) subsets of primitives defined for the scene falling within the corresponding volumes for the leaf nodes 31.

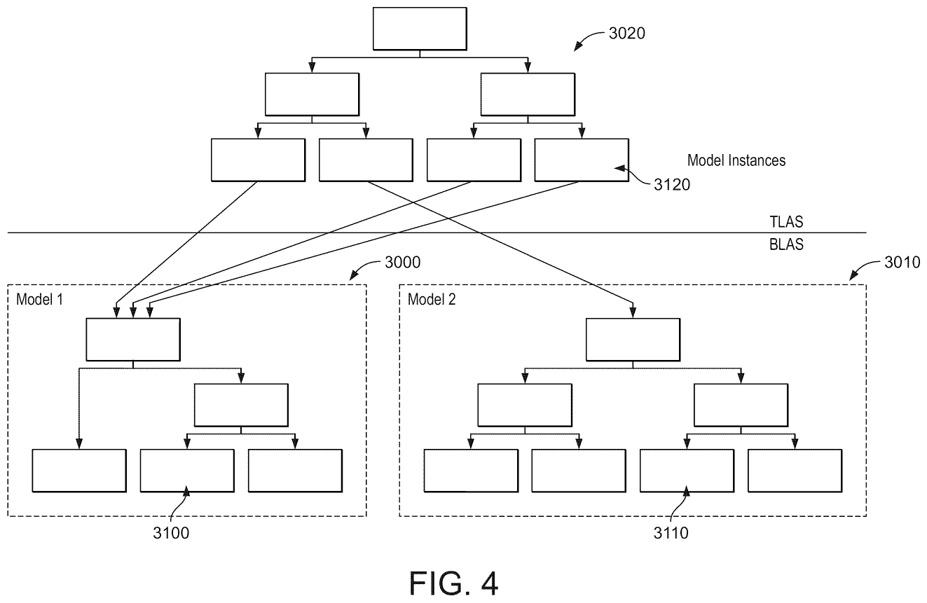

In the present embodiments, a two-level arrangement of a ray tracing acceleration data structure (BVH tree) is used to represent the distribution of geometry within the scene to be rendered. FIG. 4 shows an exemplary two-level arrangement of ray tracing acceleration data structures in which each model (object) within the scene is associated with a respective bottom-level acceleration structure (BLAS) 3000, 3010, which in the present embodiments is in the form of a respective BVH tree that stores geometry in model space, with each leaf node 3100, 3110 of the BVH tree representing a respective unique subset of primitives defined for the instance or object falling within the corresponding volume.

A separate top-level acceleration structure (TLAS) 3020 then contains references to the set of bottom-level acceleration structures (BLAS), together with a respective set of shading and transformation information for each bottom-level acceleration structure (BLAS). In the present embodiments, the top-level acceleration structure (TLAS) 3020 is defined in world space and is in the form of a BVH tree having leaf nodes 3120 that specify a volume in which one or more of the bottom-level acceleration structures (BLAS) 3000, 3010 are referenced (and that such that the leaf nodes point to the one more BLAS 3000, 3010). As can be seen from FIG. 3, there may be multiple instances of the same BLAS model.

The BVH tree acceleration data structure also stores (either for the nodes themselves or otherwise, e.g. as sideband information), appropriate information to allow the tree to be traversed volume-by-volume on the basis of the origin and direction of a ray so as to be able to identify a leaf node representing a volume that the ray passes through.

This then allows and facilitates testing a ray against the hierarchy of bounding volumes in the BVH tree until a leaf node is found. It is then only necessary to test the geometry associated with the particular leaf node for intersection with the ray.

Other forms of hierarchical data structures that may be used for accelerating a ray tracing operation (i.e. ray tracing acceleration data structures) would be possible.

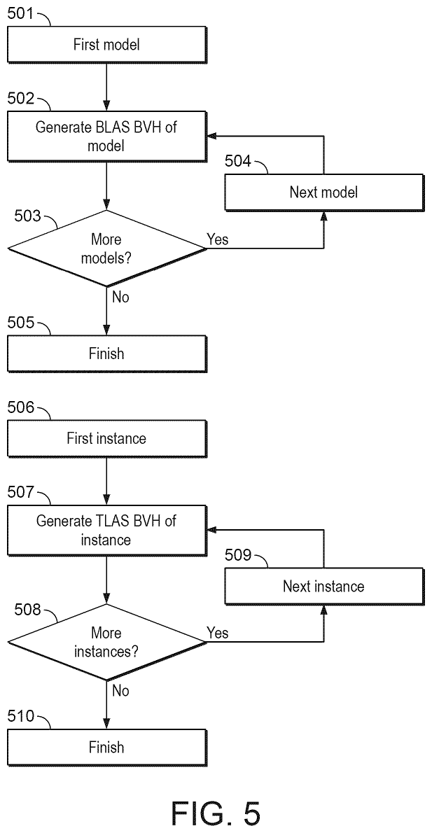

FIG. 5 shows a process for generating initial BVH ray tracing acceleration data structures.

For a first model (step 501), the BLAS BVH of the model is generated (step 502) using the geometry of the scene in question. If there are more models, then BLAS BVH is generated for each of them (steps 503 and 504).

TLAS BVH are then generated for each instance of each object (model). For a first instance (step 506), TLAS BVH is generated which points to the relevant BLAS BVH for the model in question (step 507). If there are more instances (of the same or other objects (models)), then TLAS BVH is generated for each of them (steps 508 and 509).

This generation of the initial ray tracing acceleration data structures can be done in any suitable or desired manner, e.g. by means of an initial processing pass on the graphics processor. In an embodiment, the ray tracing acceleration data structures are generated to be ‘balanced’ with respect to its node structure and the distribution of geometry that is represents, e.g. so as to facilitate more efficient traversal. Various arrangements would be possible in this regard.

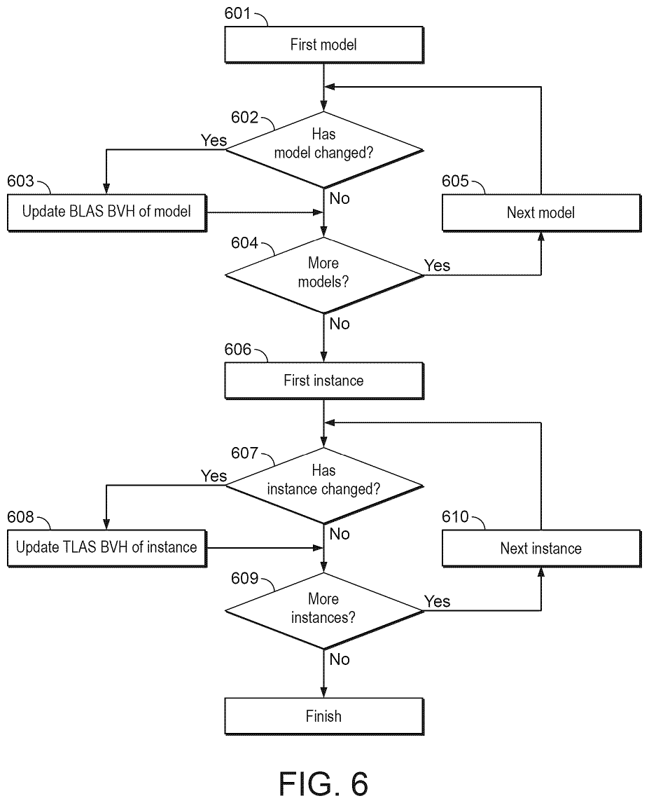

FIG. 6 shows a process for updating the ray tracing acceleration data structures.

Rather than generate complete ray tracing acceleration data from scratch for each and every frame that is rendered, in embodiments of the technology described herein, as will be explained further below, ray tracing acceleration data structures are (only) updated between frames, with only the relevant parts being modified according to changes in the scene.

For a first model (step 601), it is determined whether or not the model itself has changed (step 602). If the model has not changed, then the BLAS BVH for the model does not need to be updated. However, if the model has changed, then the BLAS BVH of the model in question is updated accordingly using geometry for the scene (step 603). This process is then repeated for each model in the scene (steps 604 and 605).

Once the BLAS BVH for models has been updated (if necessary) in this way, each instance of each object in the scene is considered. For a first instance (step 606), it is determined whether or not the instance has changed (step 607).

The instance may have changed if, for example, the object in question has moved or has changed. If the instance has not changed, then the TLAS BVH for the instance does not need to be updated. If the instance has changed (e.g. the instance has moved in the environment, or the model for the object itself has changed), then the TLAS BVH for the instance is updated (step 608). (If the object for the instance has changed, for example, such that it relates to a different model (and hence BLAS), then the TLAS is updated to point to the new BLAS. Alternatively, if there are multiple models of (and hence multiple BLAS for) the same object (e.g. a model for a new car and a model for a car with a dent) and the model that is to be used is changed (e.g. the car is damaged), then the TLAS may be updated to point to the new BLAS corresponding to the new model. Various examples would be possible in this regard.

This process is repeated for each instance (of each object) in the scene (steps 609 and 610).

The acceleration data structure may therefore be mostly static across multiple frames The TLAS data structure only need to be updated if the relevant object in the scene changes or moves. If an object does not move or change between frames, then therefore no need for the acceleration data structure to be updated (e.g. transformed or re-projected), even if the camera moves (for example).

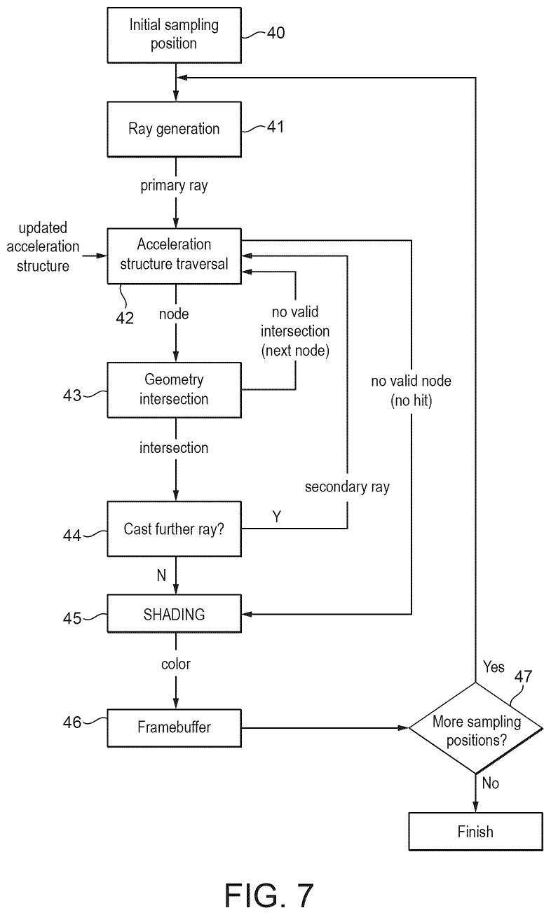

FIG. 7 is a flow chart illustrating the overall ray tracing process, and that may be performed on and by the graphics processor 2.

An updated acceleration data structure (generated by process shown in FIG. 6) for the frame is received.

For a first sampling position of the frame (step 40), a primary ray is then generated, passing from a camera through the particular sampling position in an image plane (frame) (step 41). The acceleration data structure is then traversed for the primary ray (step 42), and the leaf node corresponding to the first volume that the ray passes through which contains geometry which the ray potentially intersects is identified. It is then determined whether the ray intersects any of the geometry, e.g. primitives, (if any) in that leaf node (step 43).

If no (valid) geometry which the ray intersects can be identified in the node, the process returns to step 42, and the ray continues to traverse the acceleration data structure and the leaf node for the next volume that the ray passes through which may contain geometry with which the ray intersects is identified, and a test for intersection performed at step 43.

This is repeated for each leaf node that the ray (potentially) intersects, until geometry that the ray intersects is identified

When geometry that the ray intersects is identified, it is then determined whether to cast any further (secondary) rays for the primary ray (and thus sampling position) in question (step 44). This may be based, e.g., and in an embodiment, on the nature of the geometry (e.g. its surface properties) that the ray has been found to intersect, and the complexity of the ray tracing process being used.

Thus, as shown in FIG. 5, one or more secondary rays may be generated emanating from the intersection point (e.g. a shadow ray(s), a refraction ray(s) and/or a reflection ray(s), etc.). Steps 42, 43 and 44 are then performed in relation to each secondary ray.

Once there are no further rays to be cast, a shaded colour for the sampling position that the ray(s) correspond to is then determined based on the result(s) of the casting of the primary ray, and any secondary rays considered (step 45), taking into account the properties of the surface of the object at the primary intersection point, any geometry intersected by secondary rays, etc. The shaded colour for the sampling position is then stored in the frame buffer (step 46).

If no (valid) node which may include geometry intersected by a given ray (whether primary or secondary) can be identified in step 42 (and there are no further rays to be cast for the sampling position), the process moves to step 45, and shading is performed. In this case, the shading is in an embodiment based on some form of “default” shading operation that is to be performed in the case that no intersected geometry is found for a ray. This could comprise, e.g., simply allocating a default colour to the sampling position, and/or having a defined, default geometry to be used in the case where no actual geometry intersection in the scene is found, with the sampling position then being shaded in accordance with that default geometry. Other arrangements would, of course, be possible.

This process is performed for each sampling position to be considered in the image plane (frame) (step 47).

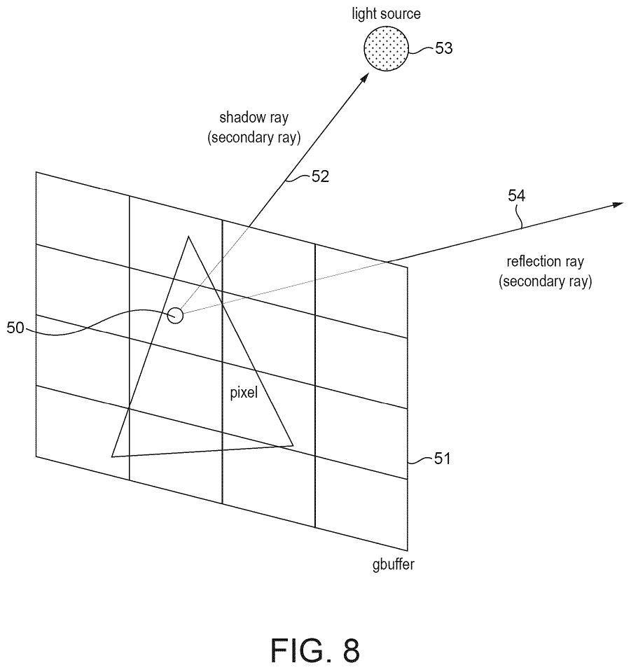

FIG. 8 shows an alternative ray tracing process which may be used in accordance with embodiments of the technology described herein, in which only some of the steps of the full ray tracing process described in relation to FIGS. 3 and 4 are performed. Such an alternative ray tracing process may be referred to as a “hybrid” ray tracing process.

In this process, as shown in FIG. 8, the first intersection point 50 for each sampling position in the image plane (frame) is instead determined first using a rasterisation process and stored in an intermediate data structure known as a “G-buffer” 51. Thus, the process of generating a primary ray for each sampling position, and identifying the first intersection point of the primary ray with geometry in the scene, is replaced with an initial rasterisation process to generate the “G-buffer”. The G-buffer includes information indicative of the depth, colour, normal and surface properties (and any other appropriate and desired data, e.g. albedo, etc.) for each first (closest) intersection point for each sampling position in the image plane (frame).

Secondary rays, e.g. shadow ray 52 to light source 53, and reflection ray 54, may then be cast starting from the first intersection point 50, and the shading of the sampling positions determined based on the properties of the geometry first intersected, and the interactions of the secondary rays with geometry in the scene.

Referring to the flowchart of FIG. 7, in such a hybrid process, the initial pass of steps 41, 42 and 43 of the full ray tracing process for a primary ray will be omitted, as there is no need to cast primary rays and determine their first intersection with geometry in the scene. The first intersection point data for each sampling position is instead obtained from the G-buffer.

The process may then proceed to the shading stage 45 based on the first intersection point for each pixel obtained from the G-buffer, or where secondary rays emanating from the first intersection point are to be considered, these will need to be cast in the manner described by reference to FIG. 7. Thus, steps 42, 43 and 44 will be performed in the same manner as previously described in relation to the full ray tracing process for any secondary rays.

The colour determined for a sampling position will be written to the frame buffer in the same manner as step 46 of FIG. 7, based on the shading colour determined for the sampling position based on the first intersection point (as obtained from the G-buffer), and, where applicable, the intersections of any secondary rays with objects in the scene, determined using ray tracing.

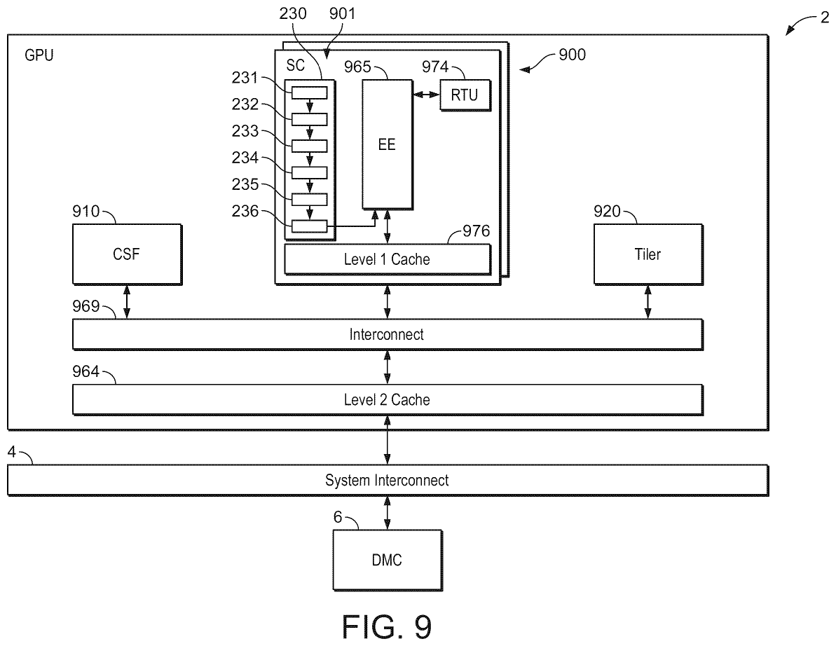

FIG. 9 shows in more detail a graphics processor (GPU) 2 that may be used to implement the technology described herein.

FIG. 9 shows the main elements of the graphics processor (GPU) 2 that are relevant to the operation of the present embodiments. As will be appreciated by those skilled in the art, there may be other elements of the graphics processor that are not illustrated in FIG. 9. It should also be noted that FIG. 9 is only schematic, and that, for example, in practice the shown functional units and pipeline stages may share significant hardware circuits, even though they are shown schematically as separate stages in FIG. 9.

As shown in FIG. 9, the tile-based graphics processor 2 includes a command stream frontend (CSF) 910, a tiler (unit) 920, and a set of shader cores 900. FIG. 9 shows two shader cores, but other numbers of shader cores are possible. FIG. 9 shows schematically the relevant configuration of one shader core 901, but as will be appreciated by those skilled in the art, further shader cores of the graphics processor 2 can be configured in a corresponding manner (although there may be some differences between different shader cores of the graphics processor 2).

Each shader core 900 of the graphics processor 2 includes an appropriate programmable execution unit (execution engine) 965 that is operable to execute graphics shader programs for execution threads to perform graphics processing operations. In order to perform graphics processing operations, the programmable execution unit 965 will execute graphics shader programs (sequences of instructions) for respective execution threads (e.g. corresponding to respective sampling positions of a frame to be rendered). The instructions to be executed will be fetched from memory system 6 via an interconnect 969.

As shown in FIG. 9, the shader core 901 in this embodiment also includes a ray tracing circuit (unit) (“RTU”) 974, which is in communication with the programmable execution unit 965, and which is operable to perform some or all of the processing operations for a ray tracing process. For example, in the present embodiments, ray tracing circuit (unit) (“RTU”) 974 is operable to perform (at least) the required geometry intersection determinations for rays being processed as part of a ray tracing-based rendering process (i.e. the operations of steps 42 and 43 of FIG. 7 of traversing the acceleration data structure to determine with reference to the node volumes of the acceleration data structure geometry that is potentially intersected by the ray and the corresponding ray-primitive testing to determine which geometry, if any, is actually intersected by the ray), in response to messages received from the programmable execution unit 965.

Various other arrangements would be possible in this regard and the ray tracing circuit (unit) (“RTU”) 974 may generally accelerate any or all of the processing operations as part of a ray tracing-based rendering process (i.e. any of the operations described above in relation to FIG. 7 or FIG. 8).

(Although in the present embodiment the processing operations for ray tracing are performed by the RTU, in other embodiments these processes could be performed elsewhere, e.g. by the host processor (CPU) 1, or by a (shader) program executed by the programmable execution unit (execution engine) 965.)

The RTU 974 is also able to communicate with the level 1 cache 976 for loading in the required data for such intersection testing, such as the node data defining the nodes to be tested (e.g. which node data may include data identifying a set of primitives, but could also identify a BLAS to be traversed, for example).

The command stream frontend 910 receives commands and data from the driver 11 (directly, or via data structures in memory), and distributes subtasks for execution to the tiling unit 920 and to the shader cores 900 appropriately.

The graphics processor 2 of FIG. 9 is a tile-based graphics processor. In a tile-based rendering system the render output (e.g. frame for display) is divided into a plurality of rendering tiles. Typically, each rendering tile is 16×16, 32×32, or 64×64 data elements (sampling positions) in size, with the render output being divided into however many such rendering tiles as are required for the render output size and shape that is being used. The rendering tiles are rendered separately to generate the render output. To do this, for each draw call that is received to be processed, it is first necessary to sort the primitives (polygons) for the draw call according to which rendering tiles they should be processed for.

In order to facilitate this, the tiling unit 920 is operable to perform a first processing pass in which lists of primitives to be processed for different regions of the render output are prepared. These “primitive lists” (which can also be referred to as a “tile list” or “polygon list”) identify the primitives to be processed for the region in question.

As part of this processing pass, the tiler 920 and/or command stream frontend (CSF) 910 may request vertex processing tasks to be performed by the set of shader cores 900 to generate processed (transformed) vertex data that the tiling unit 220 uses to prepare primitive lists. This “vertex shading” operation may comprise, for example, transforming vertex position attributes from the model space that they are initially defined for to the screen space that the output of the graphics processing is to be displayed in.

Once all of the vertex processing and tiling has been completed, the transformed geometry and the primitive lists are written back to the main memory 6, and the first processing pass is complete.

A second processing pass is then performed for the render output, wherein primitives are rasterised for each of tiles and each of the tiles is rendered (separately).

In this processing pass, the fragment frontend 230 of a shader core 901 receives fragment processing tasks from the command stream frontend (CSF) 910, and in response, tile tracker 231 schedules the rendering work that the shader core needs to perform in order to generate a tile. Primitive list reader 232 then reads the appropriate primitive list(s) for that tile from the memory 6 to identify the primitives that are to be rendered for the tile.

Resource allocator 233 then configures various elements of the graphics processor 100 for rendering the primitives that the primitive list reader 232 has identified are to be rendered for the tile. For example, the resource allocator 233 may appropriately configure a local tile buffer for storing output data for the tile being rendered.

Vertex fetcher 234 then reads the appropriate processed (transformed) vertex data for primitives to be rendered from the memory 6, and provides the primitives (i.e. their processed vertex data) to triangle set-up unit 235. The triangle set-up unit 235 performs primitive setup operations to setup the primitives to be rendered. This includes determining, from the vertices for the primitives, edge information representing the primitive edges. The edge information for the primitives is then passed to the rasteriser 236.

When the rasteriser 236 receives a graphics primitive for rendering (i.e. including its edge information), it rasterises the primitive to sampling points and generates one or more graphics fragments having appropriate positions (representing appropriate sampling positions) for rendering the primitive.

Fragments generated by the rasteriser 236 may then be subject to “culling” operations, such as depth testing, to see if any fragments can be discarded (culled) at this stage. Execution threads are then issued to execution engine 965 for processing fragments that have survived the culling stage.

The execution engine 965 executes a shader program for each execution thread issued to it to generate appropriate render output data. The rendering engine 965 may perform graphics processing operations, including ray-tracing based operations (via communication with the RTU 974, as discussed above). Output data generated by the execution engine 965 is then written appropriately to the tile buffer (not shown).

Once a tile has been processed, its data is exported from the tile buffer to the main memory 6 (e.g. to a frame buffer in the main memory 6) for storage, and the next tile is then processed, and so on, until sufficient tiles have been processed to generate the entire render output (e.g. a frame buffer or a frame (image) to be displayed). The next render output (e.g. frame) may then be generated, and so on.

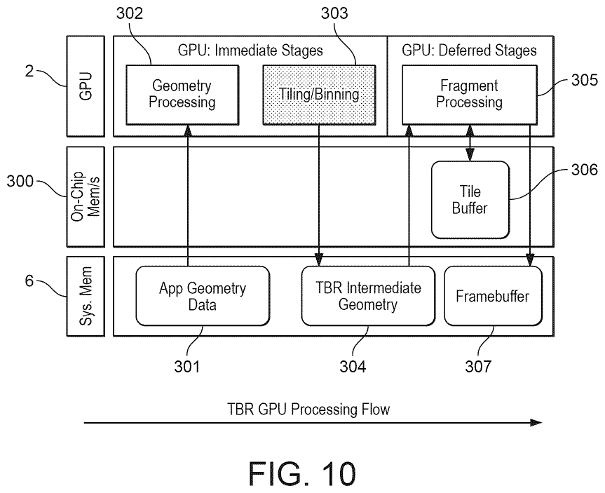

FIG. 10 shows schematically a more traditional tile-based rendering process. As shown in FIG. 10, in the first processing pass, the required geometry data 301 for a draw call is read from the external memory system 6 into the graphics processor 100. The primitive vertices are thus obtained and the geometry processing 302 (vertex shading) is performed in order to generate a corresponding set of post-transformed geometry data (e.g. transformed vertices) 304.

The transformed geometry is subject to a tiling operation 303 by the tiling unit 220 of the graphics processor 100, wherein it is determined for each of the primitives which rendering tiles the primitives should be processed for. The tiling unit may also operate to cull primitives that are outside of the view frustum, or are back facing. In this way, respective primitive lists are generated that indicate which primitives are to be rendered for which of the rendering tiles.

For modern graphics processors, the geometry data for the render output can be relatively large such that it cannot be effectively cached in local storage associated with the graphics processor. Thus, as shown in FIG. 10, once all of the geometry processing for the render output has completed, and the tiling operating has completed, the transformed geometry 304 is written back to the external memory system 6 together with the primitive lists, and the first processing pass is complete.

The second processing pass is then performed wherein each of the rendering tiles is rendered (separately) in turn. Thus, for each rendering tile, it is determined from the respective primitive list(s) which primitives should be processed for that tile, and the associated transformed geometry data 304 for those primitives is read back in from memory 6 and subject to fragment processing 305 to generate the render output.

As shown in FIG. 10, the rendering is performed using a tile buffer 306 that resides in on-chip memory 300. Thus, the rendering of a given tile is performed locally to the graphics processor 100. Once the rendering for the tile has complete, the rendered data is then written out to the external memory 6, e.g. into a frame buffer 307, e.g. for display.

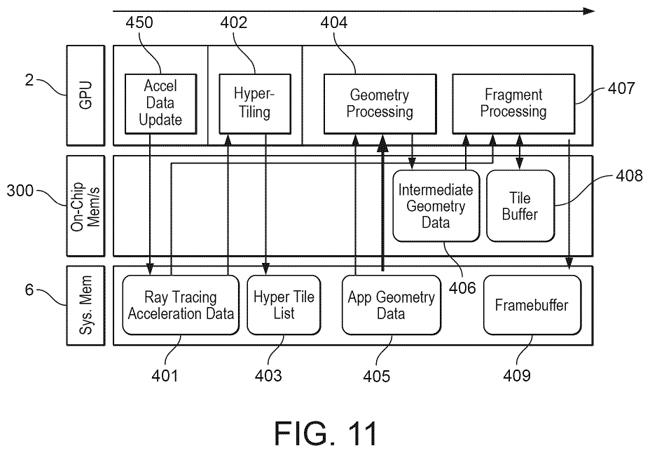

FIG. 11 shows a “hypertiling” rendering process according to an embodiment of the technology described herein. In the “hypertiling” rendering process the render output is initially divided for sorting purposes into a number of relatively larger, e.g. 256×256 sampling position, “hypertiles”. These hypertiles are thus larger than the rendering tiles discussed above.

The effect and benefit of this initial sorting into “hypertiles” is thus that the amount of data that needs to be stored for a particular hypertile is reduced, e.g., and in an embodiment, such that all of the geometry data for processing that hypertile can be stored entirely in on-chip memory (and the size of the hypertiles may be selected to ensure this is the case, e.g. based on the size of the on-chip memory). In addition, each hypertile can be processed separately (and independently), e.g. in parallel. For example, different hypertiles may potentially be processed by different graphics processors.

The “hypertiling” sorting process according to the present embodiments may thus be performed to similar effect as the “hypertiling” sorting process that is described in United States Patent Application (Publication) No. US 2023-0401667 (Arm Limited), the entire content of which is incorporated herein by reference. Thus, the result of the “hypertiling” sorting process according to the present embodiments may be to sort geometry into “hypertile lists”.

According to the present embodiments, however, the actual sorting of geometry into such “hypertile lists” can be (and is) performed using a ray tracing acceleration data structure, such as the BVH described above, which ray tracing acceleration data is used to sort instances of objects in the scene to be rendered into the desired “hypertile lists”.

As shown in FIG. 11, a ray tracing acceleration data update stage 450 first updates the ray tracing acceleration data structures 401 for the frame to be rendered (e.g. according to the process shown in FIG. 6, as discussed above).

The updated ray tracing acceleration data structures 401 are read from their location in memory 6 into the graphics processor 100, and an initial sorting (“hypertiling”) operation 402 is then performed to sort the instances of objects in the scene to be rendered into respective hypertile lists, indicating which instances cover which hypertiles.

As discussed further below, the hypertiling process includes converting each of the hypertiles into a volume in world space, to determine whether the volume of the hypertile intersects with, e.g., the TLAS volume node specified for an instance of an object in the scene to be rendered (such that the instance can be said to “cover” (at least in part) the hypertile).

Thus, the hypertiling operation in an embodiment uses the ray tracing acceleration data structures 401 to generate the respective hypertile lists. Where there are multiple ray tracing acceleration data structures 401, the hypertiling operation may generally use some or all of the ray tracing acceleration data structures 401 (and may use some or all of any particular ray tracing acceleration data structure). For example, where there are multiple ray tracing acceleration data structures 401, such as a TLAS and multiple BLAS, the hypertiling operation could interrogate both the TLAS and BLAS, but in embodiments only the TLAS is interrogated.

Once the hypertile lists 403 are generated, they are written back out to external memory 6.

Once the hypertile lists 403 have been generated, a subsequent processing pass is performed wherein each hypertile is rendered separately. To do this, the graphics processor 2 identifies from the respective hypertile lists 403 the instances (TLAS nodes) that fall within the specified hypertile, and interrogates the BLAS that the relevant TLAS points to, to determine the geometry that should be processed for the hypertile. The required geometry 405 is then read into the graphics processor 100 from the external memory 6.

The geometry processing 404, including the vertex shading, and finer tiling of the geometry into respective rendering tiles into which the hypertile is divided for rendering, is then performed at this stage.

The rendering of the hypertiles can then proceed, e.g. in substantially the same manner described above. Thus, the intermediate geometry data 406, including the tile lists, is read into the graphics processor 100 and the fragment processing 407 is performed by one or more of the shader cores using the tile buffer 408 in a similar fashion as described above, with the rendered data being written into a suitable frame buffer 409 in external memory 6, e.g. for subsequent display.

Thus, the processing for each hypertile involves first reading in the hypertile list from memory 6, to determine the instances of objects in the scene that fall within the hypertile (and their associated geometry), and then performing the geometry processing (e.g. vertex shading, etc.) and a per primitive tiling operation wherein the primitives are sorted into rendering tiles. The fragment processing (which may include ray tracing operations) is then performed as described above in a further processing pass to render the tiles.

Thus, there are in effect two sorting operations: a first, (higher level) hypertiling operation to sort the instances in the scene being rendered into the hypertiles (on the basis of the (updated) ray tracing acceleration data structure for the scene being rendered), and a second, (finer) tiling operation to sort the primitives for those instances into the respective rendering tiles.

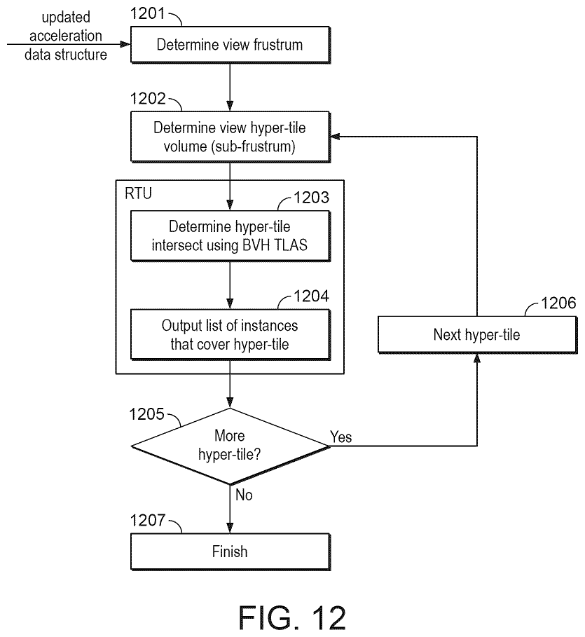

FIG. 12 is a flow chart showing the hypertiling sorting process in further detail.

First, the updated acceleration data structure for the frame (generated by process shown in FIG. 6) is received.

In step 1201, the view frustum for the frame being generated is determined. As will be understood, the view frustum corresponds to the field of view of the camera, and is in camera space. The view frustum is a three dimensional shape defined by a near plane, a front plane, and four sides (top, bottom, left and right).

In step 1202, the volume of a particular hypertile (in world space) is determined, on the basis of a determined volume of the view frustum (in world space). In this example, the frame to be rendered is divided into four (equally sized) hypertiles. Hence, to find determine the volume of a particular hypertile, the volume of the relevant quadrant of the view frustum is determined.

In step 1203, performed by the RTU 974, nodes of the TLAS (relating to volumes occupied by respective instances of the objects of the scene being rendered) are tested against the determined volume of the hypertile, to determine whether or not they intersect, i.e. such that it can be said that the respective instances that the TLAS nodes relate to “cover” (at least in part) the hypertile in question.

Each instance (i.e. node) that is determined to cover the hypertile is then added to a list for the hypertile, which is then output (step 1204).

The process is then repeated for each hypertile that the render output (frame) is divided into (steps 1205 and 1206).

Once, the hypertiling sorting process is complete, and a list of instances (i.e. TLAS nodes) for each hypertile has been output, the hypertiling sorting process finishes (step 1207) and a hypertiling rasterization process begins.

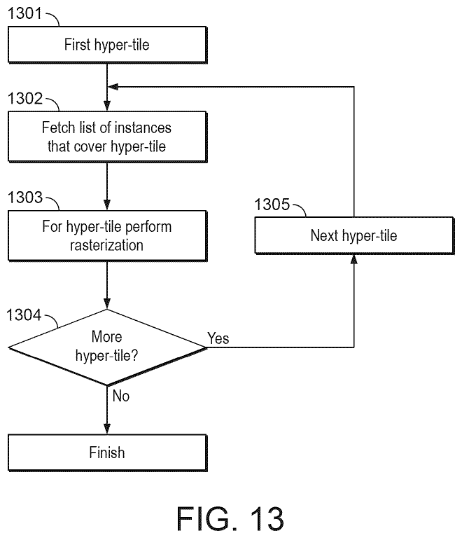

FIG. 13 is a flow chart showing this rasterization process according to an embodiment of the technology described herein.

For a first hypertile (step 1301), the hypertile list comprising a list of instances (TLAS nodes) that cover the hypertile is fetched (1302). The BLAS which the TLAS nodes point to are then interrogated, and the primitives that the BLAS point to are returned.

Once a list of primitives to be processed for the hypertile have been determined in this manner, normal rasterization can be performed for the hypertile (i.e. by sorting the primitives to be processed for the hypertile into primitive lists for respective tiles of the hypertile, in the manner discussed above) (step 1303). This normal rasterization may be, and in the present embodiments is, part of a “hybrid” ray tracing process, which ray tracing process then uses the same ray tracing acceleration data structures as were used for the hypertiling sorting process.

The process is repeated for all four hypertiles (steps 1304 and 1305).

Thus, it will be appreciated from the above, a particular effect and benefit of the present embodiments is that when the rasterization process is part of a “hybrid” ray tracing process, the (same) ray tracing acceleration data structure that is used for the hypertiling sorting process (e.g. as shown in FIG. 12) can also be used for the rasterization process. Various arrangements would however be possible.

For example, if a more traditional rasterization process were used, a suitable (hierarchical) ‘ray tracing acceleration’ data structure may need to be generated specifically for the hypertiling sorting process (which may in that case be a relatively coarser data structure, e.g. only containing a TLAS).

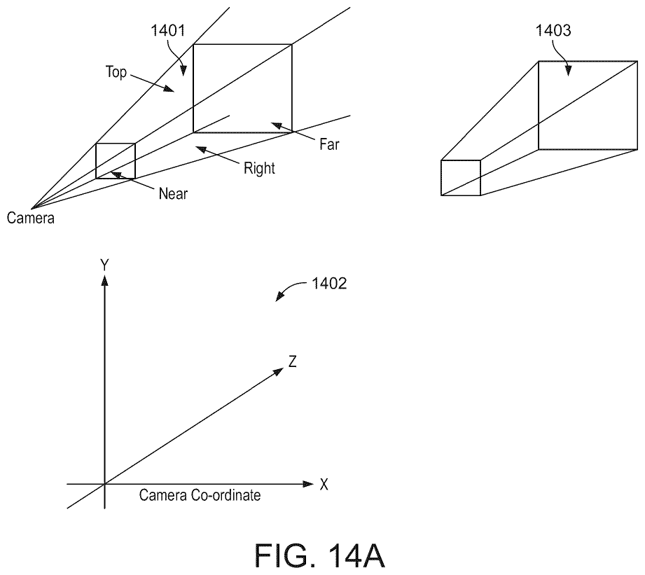

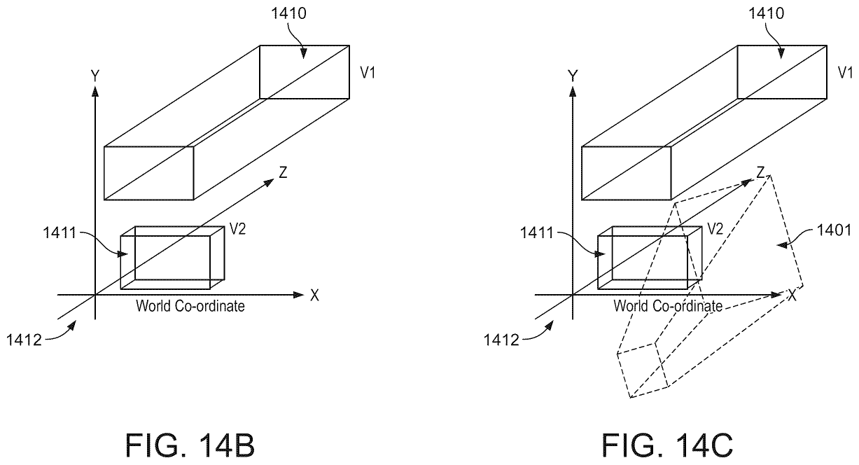

In the embodiments discussed above, the volume of a hypertile (in world space) is determined on the basis of the view frustum, and this volume is then used to determine whether instances of objects in the scene being rendered fall within the hypertile. This process is shown in further detail in FIGS. 14A-14C.

FIG. 14A shows a view frustum for a render output (frame) that is generated. The view frustum 1401 is defined by its front plane, back plane, and four sides (top, bottom, left and right), and is in camera space 1402. The volume 1403 of the view frustum in camera space is also shown.

FIG. 14B shows an example world space 1412 of a scene being rendered. Instances 1410 and 1411 of two objects (having volumes V1 and V2 respectively) occupy the world space 1412. The volumes V1 and V2 of these objects (instances) correspond to respective nodes in the TLAS.

FIG. 14C shows that same world space 1412, but with the volume of the view frustum 1401 superimposed. As can be seen, the view frustum 1401 thus extends into the world space. It can thus be determined which volumes intersect the view frustum 1401. For example, as shown in FIG. 14C, it can be seen in this example that the volume V2 of instance 1411 intersects (i.e. partially overlaps) with the volume of the view frustum in world space.

In the embodiment discussed above, it is determined whether instances (corresponding to TLAS nodes) of objects in the scene being rendered fall within the volume of hypertiles (in world space), with instances (i.e. TLAS nodes) that are determined to fall within the view frustum for a particular hypertile then being added to the hypertile list for that hypertile. When performing rasterization for the hypertile, this list of instances is then fetched, and the BLAS which the TLAS nodes on the list point to are interrogated in order to determine the primitives that should be processed for the hypertiles

However, instead of adding instances (TLAS nodes) to the hypertile list (which are later used to determine primitives that should be processed) in the hypertile sorting process, it would instead be possible to interrogate the BLAS that the TLAS nodes point to at the hypertile sorting stage, and add the relevant primitives (for the model(s)) (rather than instances) to the hypertile list directly. In this case, since the hypertile list would comprise a list of primitives (rather than a list of instances), when performing rasterization for the hypertile, the list of primitives to be processed for the hypertile can be read directly from the hypertile list.

Various arrangements would be possible in this regard.

The effect and benefit of all this then is that the geometry to be processed for the render output can at least in embodiments of the technology described herein be sorted into different regions (e.g. hypertiles) while doing much less geometry processing to achieve that (and correspondingly deferring the geometry work of transforming the individual vertex positions, for example). This can then provide various improvements in terms of graphics processor operation, e.g. as described above.

The foregoing detailed description has been presented for the purposes of illustration and description. It is not intended to be exhaustive or to limit the technology described herein to the precise form disclosed. Many modifications and variations are possible in the light of the above teaching. The described embodiments were chosen in order to best explain the principles of the technology described herein and its practical applications, to thereby enable others skilled in the art to best utilise the technology described herein, in various embodiments and with various modifications as are suited to the particular use contemplated. It is intended that the scope be defined by the claims appended hereto.

1. A method of operating a graphics processor to generate a render output, the render output representing a view of a scene comprising one or more objects, each object having a set of geometry defined for it, the method comprising:
determining which sets of geometry should be further processed for which region or regions of a plurality of regions into which the render output has been divided for rendering; and
rendering a region of the render output by processing the sets of geometry determined to be further processed for that region,
wherein the determining which sets of geometry should be further processed for which region or regions of the plurality of regions into which a render output has been divided for rendering uses a hierarchical data structure representing a plurality of volumes in a world space coordinate system, wherein a volume contains one or more sets of geometry, the hierarchical data structure thus being indicative of the distribution of geometry for the scene to be rendered in the world space coordinate system.

2. The method of claim 1, wherein determining which sets of geometry should be further processed for which region or regions of the plurality of regions into which the render output has been divided comprises:
determining a volume in the world space coordinate system that a particular region of the render output corresponds to; and
testing the volume in the world space world space coordinate system that the particular region of the render output corresponds to for intersection with one or more volumes represented by the hierarchical data structure to determine whether the geometry contained within those volumes falls within the particular region and should thus be further processed for that particular region.

3. The method of claim 2, wherein determining a volume in the world space coordinate system that a particular region of the render output corresponds to comprises determining a volume in the world space coordinate system of a view frustum for the particular region of the render output.

4. The method of claim 1, further comprising performing a ray tracing operation using the hierarchical data structure.

5. The method of claim 4, wherein the graphics processor comprises a programmable execution unit operable to execute graphics processing programs and also comprises a ray tracing circuit that can be messaged by the programmable execution unit as part of a program to perform ray tracing to perform some or all of the ray tracing operation, and wherein some or all of the determining which sets of geometry should be processed for which region or regions of a plurality of regions into which the render output has been divided for rendering is performed using the ray tracing circuit.

6. The method of claim 1, wherein the hierarchical data structure comprises a bounding volume hierarchy tree data structure.

7. The method of claim 6, wherein the bounding volume hierarchy tree data structure comprises a top-level acceleration structure (TLAS) wherein at least some leaf nodes of the top-level acceleration structure represent instances of objects within the scene, wherein an instance of an object within the scene is associated with a respective bottom-level acceleration structure (BLAS), at least some leaf nodes of the bottom-level acceleration structure (BLAS) containing the sets of geometry for the associated object, and wherein the determining which sets of geometry should be further processed for which region or regions of the plurality of regions into which the render output has been divided for rendering comprises determining whether a volume represented by the top-level acceleration structure (TLAS) falls within a region of the render output.

8. The method of claim 7, wherein the determining which sets of geometry should be further processed for which region or regions of the plurality of regions into which the render output has been divided for rendering does not use any bottom-level acceleration structures (BLAS) of the bounding volume hierarchy tree data structure.

9. The method of claim 1, comprising processing the sets of geometry to generate a render output using tile-based rendering, wherein each of the regions that the render output was divided into for sorting is subdivided into a plurality of rendering tiles, each rendering tile representing a sub-area of the render output region, and wherein the rendering of a region comprises a step of preparing a set of one or more tile lists indicating which of the sets of geometry that have been indicated to be processed for the region should be processed for which of the rendering tiles.

10. The method of claim 1, wherein the hierarchical data structure indicative of the distribution of geometry for the scene to be rendered is generated by updating some but not all of a hierarchical data structure e indicative of the distribution of geometry for a scene represented by a render output that was previously rendered by the graphics processor.

11. A graphics processor operable to generate a render output, the render output representing a view of a scene comprising one or more objects, each object having a set of geometry defined for it, the graphics processor comprising:
a sorting circuit operable to determine which sets of geometry should be further processed for which region or regions of a plurality of regions into which the render output has been divided for rendering;
a rendering circuit operable to render regions of the render output by processing sets of geometry determined to be further processed for that region;
wherein the sorting circuit is operable and configured to use a hierarchical data structure to determine which sets of geometry should be further processed for which region or regions of the plurality of regions into which a render output has been divided for rendering, the hierarchical data structure representing a plurality of volumes in a world space coordinate system, wherein a volume contains one or more sets of geometry, the hierarchical data structure thus being indicative of the distribution of geometry for the scene to be rendered in the world space coordinate system.

12. The graphics processor of claim 11, wherein the sorting circuit is operable to determine which sets of geometry should be further processed for which region or regions of the plurality of regions into which the render output has been divided by:
determining a volume in the world space coordinate system that a particular region of the render output corresponds to; and
testing the volume in the world space coordinate system that a particular region of the render output corresponds to for intersection with one or more volumes represented by the hierarchical data structure to determine whether the geometry contained within those volumes falls within the particular region and should thus be further processed for that particular region.

13. The graphics processor of claim 12, wherein the sorting circuit is operable to determine a volume in the world space coordinate system that a particular region of the render output corresponds to by determining a volume in the world space coordinate system of a view frustum for the particular region of the render output.

14. The graphics processor of claim 11, further comprising a ray tracing circuit operable to perform a ray tracing operation using the hierarchical data structure.

15. The graphics processor of claim 14, wherein the graphics processor comprises a programmable execution unit operable to execute graphics processing programs and also comprises a ray tracing circuit that can be messaged by the programmable execution unit as part of a program to perform ray tracing to perform some or all of the ray tracing operation, and wherein some or all of the determining which sets of geometry should be processed for which region or regions of a plurality of regions into which the render output has been divided for rendering is performed using the ray tracing circuit, the sorting circuit comprising or having access to the ray tracing circuit.

16. The graphics processor of claim 11, wherein the hierarchical data structure comprises a bounding volume hierarchy tree data structure.

17. The graphics processor of claim 11, wherein the bounding volume hierarchy tree data structure comprises a top-level acceleration structure (TLAS) wherein at least some leaf nodes of the top-level acceleration structure represent instances of objects within the scene, wherein an instance of an object within the scene is associated with a respective bottom-level acceleration structure (BLAS), at least some leaf nodes of the bottom-level acceleration structure (BLAS) containing the sets of geometry for the associated object, and wherein the sorting circuit is operable to determine which sets of geometry should be further processed for which region or regions of the plurality of regions into which the render output has been divided for rendering by determining whether a volume represented by the top-level acceleration structure (TLAS) falls within a region of the render output.

18. The graphics processor of claim 17, wherein the sorting circuit is operable to determine which sets of geometry should be further processed for which region or regions of the plurality of regions into which the render output has been divided for rendering does without using any bottom-level acceleration structures (BLAS) of the bounding volume hierarchy tree data structure.

19. The graphics processor of claim 11, wherein the rendering circuit comprises a tile-based rendering circuit that is operable to generate the render output using tile-based rendering, wherein each of the regions that the render output was divided into for sorting is subdivided into a plurality of rendering tiles, each rendering tile representing a sub-area of the render output region, and wherein the tile-based rendering circuit is operable to render a region of the render output by preparing a set of one or more tile lists indicating which of the sets of geometry that have been indicated to be processed for the region should be processed for which of the rendering tiles.

20. A non-transitory computer readable storage medium storing computer software code which, when executing on a processor, performs a method of operating a graphics processor to generate a render output, the render output representing a view of a scene comprising one or more objects, each object having a set of geometry defined for it, the method comprising:
determining which sets of geometry should be further processed for which region or regions of a plurality of regions into which the render output has been divided for rendering; and
rendering a region of the render output by processing the sets of geometry determined to be further processed for that region,
wherein the determining which sets of geometry should be further processed for which region or regions of the plurality of regions into which a render output has been divided for rendering uses a hierarchical data structure representing a plurality of volumes in a world space coordinate system, wherein a volume contains one or more sets of geometry, the hierarchical data structure thus being indicative of the distribution of geometry for the scene to be rendered in the world space coordinate system.
